(19) United States
(12) Patent Application Publication
(10) Pub. No.: US 2014/0219494 A1
(43) Pub. Date: Aug. 7, 2014

(54) FLAT TYPE SPEAKER COMBINING N MAGNET AND N+1 VOICE COIL PLATE

(71) Applicant: Dong-Man Kim, Seoul-si (KR)

(72) Inventor: Dong-Man Kim, Seoul-si (KR)

(73) Assignee: EXELWAY INC., Seoul-si (KR)

(21) Appl. No.: 14/129,606

(22) PCT Filed: Jun. 13, 2012
(86) PCT No.: PCT/KR2012/004642

§ 371 Date: Feb. 12, 2014

(30) Foreign Application Priority Data
Jun. 28, 2011 (KR) 10-2011-0062819

(51) Int. Cl. H04R 9/04

(52) U.S. Cl. CPC H04R 9/046
USPC 381/400

(57) ABSTRACT

The present invention relates to a flat-type speaker, and more particularly, to a flat-type speaker having one magnet for transferring vibration into a diaphragm and two voice coil plates in one magnetic circuit, wherein the voice coil plates are coupled to both sides of the magnet. The flat-type speaker in which n magnets and n+1 voice coil plates are coupled to each other consists essentially of: the magnet positioned on a central portion; a pair of yoke plates having magnetic bodies spaced a predetermined distance apart from the magnet, such that the magnet is between the yoke plates; two voice coil plates having voice coils inserted between the magnet and one of the yoke plates and between the magnet and the other yoke plate; and a diaphragm vibrated by receiving the vibration of the voice coil plates in a state where the diaphragm contacts upper ends of the voice coil plates.

### TECHNICAL FIELD

The present invention relates to a flat-type speaker, and more particularly, to a flat-type speaker which includes one magnet for transferring vibration to a diaphragm and two voice coil plates coupled to both sides of the magnet such that the two voice coil plates can transfer vibration to the diaphragm in one magnetic circuit.

### BACKGROUND ART

In general, a speaker includes a voice coil and a diaphragm interposed between magnets, and the diaphragm is vibrated by movements of the voice coil so as to generate sounds.

A flat-type speaker includes a flat-type voice coil and magnets arranged on both sides of the voice coil at a predetermined interval and generates an induced electromotive force by the Fleming's left-hand rule and the Lorentz force law so as to form frequencies according to voices, such that the frequencies vibrate the diaphragm to be reproduced as sounds.

The voice coil is coiled on a single side or on both sides of a plate-type coil base into an oval shape or pattern-printed so as to form a voice coil plate.

The diaphragm is attached to an upper end portion of the voice coil plate in a longitudinal direction, such that the diaphragm is vibrated according to movements of the voice coil plate so as to generate sounds.

Recently, in order to increase output capacity and output efficiency of the flat-type speaker, parts of various kinds have been developed, and various efforts to enhance the flat-type speaker have been made.

### DISCLOSURE

### Technical Problem

Accordingly, the present invention has been made in an effort to solve the above-mentioned problems occurring in the prior arts, and it is an object of the present invention to provide a flat-type speaker in which two voice coil plates are respectively joined to both sides of one bar magnet in such a way that the two voice coil plates hit a diaphragm in one magnetic circuit, thereby preventing divided vibration.

It is another object of the present invention to provide a flat-type speaker which can use the entire magnetic field formed at both sides of one magnet, thereby maximizing efficiency of the magnetic circuit with no leakage of magnetic field.

It is a further object of the present invention to provide a flat-type speaker which uses one magnet to two voice coil plates, thereby reducing manufacturing costs, maximizing output capacity, and miniaturizing the size of the speaker.

### Technical Solution

To achieve the above objects, the present invention provides a flat-type speaker including: one magnet located at a central portion; a pair of yoke plates spaced apart from the magnet at a predetermined interval in such a way that the magnet is interposed between the yoke plates; two voice coil plates respectively having voice coils which are inserted between the magnet and one of the yoke plates and between the magnet and the other one of the yoke plates; and a diaphragm vibrated by receiving vibration of the voice coil plates in a state where the diaphragm gets in contact with upper ends of the voice coil plates.

In another aspect of the present invention, there is a flat-type speaker including: at least two magnets located at a central portion and spaced apart from each other at a predetermined interval; a pair of yoke plates spaced apart from the magnets at a predetermined interval in such a way that the magnets are interposed between the yoke plates; voice coil plates respectively having voice coils which are inserted between the magnets and one of the yoke plates and between the magnets and the other one of the yoke plates; and a diaphragm vibrated by receiving vibration of the voice coil plates in a state where the diaphragm gets in contact with upper ends of the voice coil plates.

Here, first and second lead plates respectively are in face-to-face contact between the voice coil plates and the diaphragm.

Moreover, the first lead plate comprises: base splines getting in face-to-face contact with upper ends of the voice coil plates and getting in face-to-face contact with a lower surface of the diaphragm; a series connection spline for connecting central portions of the base splines; and connection terminals formed at front ends of the base splines so as to be electrically connected with the voice coils formed on the voice coil plates.

Furthermore, the second lead plate comprises: base splines getting in face-to-face contact with upper ends of the voice coil plates and getting in face-to-face contact with a lower surface of the diaphragm; wing splines outwardly formed from central portions of the base splines; and connection terminals formed at front ends of the wing splines for receiving electricity from the outside.

Additionally, the yoke plates are formed in a shape of ‘ [symbol] ’ or in a shape of ‘=’ in section by being joined with each other integrally or separately.

In addition, a rectangular damper is joined to lower end portions of the two voice coil plates and comprises a plurality of damper bridges spaced apart from each other and disposed for connecting damper frames with each other, and lower end surfaces of the two voice coil plates are respectively seated on seating portions located at vertically central portions of the damper bridges.

### Advantageous Effects

According to the exemplary embodiments of the present invention, the flat-type speaker can prevent divided vibration because the two voice coil plates are respectively joined to both sides of one bar magnet in such a way that the two voice coil plates hit the diaphragm in one magnetic circuit, maximize efficiency of the magnetic circuit with no leakage of magnetic field because it can use the entire magnetic field formed at both sides of one magnet, reduce manufacturing costs, maximize output capacity, and miniaturize the size of the speaker.

### DESCRIPTION OF DRAWINGS

FIG. 1 is an assembly diagram of a flat-type speaker in which two voice coil plates are joined to one magnet according to a preferred embodiment of the present invention.

FIG. 2 is a sectional view of the flat-type speaker in which the two voice coil plates are joined to one magnet according to the preferred embodiment of the present invention.

FIG. 3 is an exploded perspective view of the flat-type speaker in which the two voice coil plates are joined to one magnet according to the preferred embodiment of the present invention.

FIG. 4 is a perspective view showing structures and connection structures of the voice coil plates, lead plates and a damper of the flat-type speaker according to the present invention.

FIG. 5 is a sectional view of a flat-type speaker in which n+1 voice coil plates are joined to n magnets according to another preferred embodiment of the present invention.

### MODE FOR INVENTION

Hereinafter, referring to the attached drawings, a structure and an action of a flat-type speaker in which n+1 voice coil plates are joined to n magnets according to a preferred embodiment of the present invention will be described.

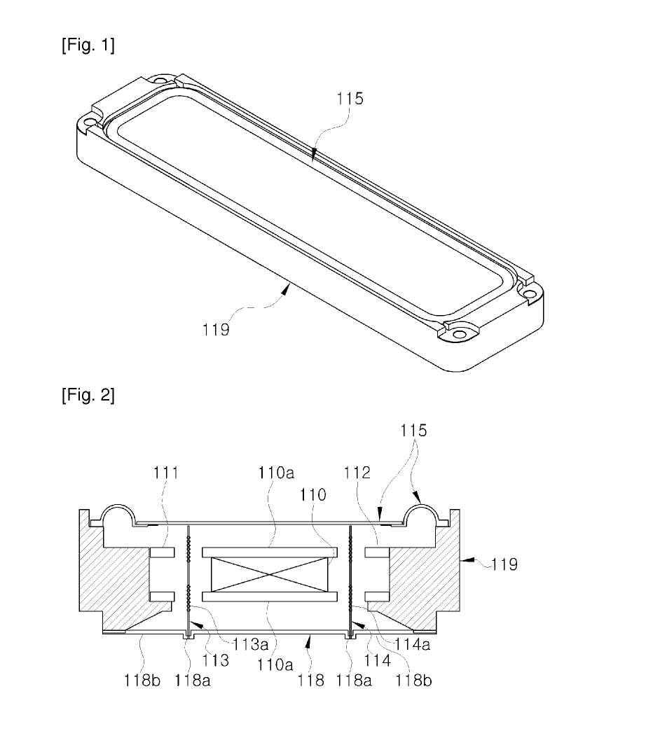

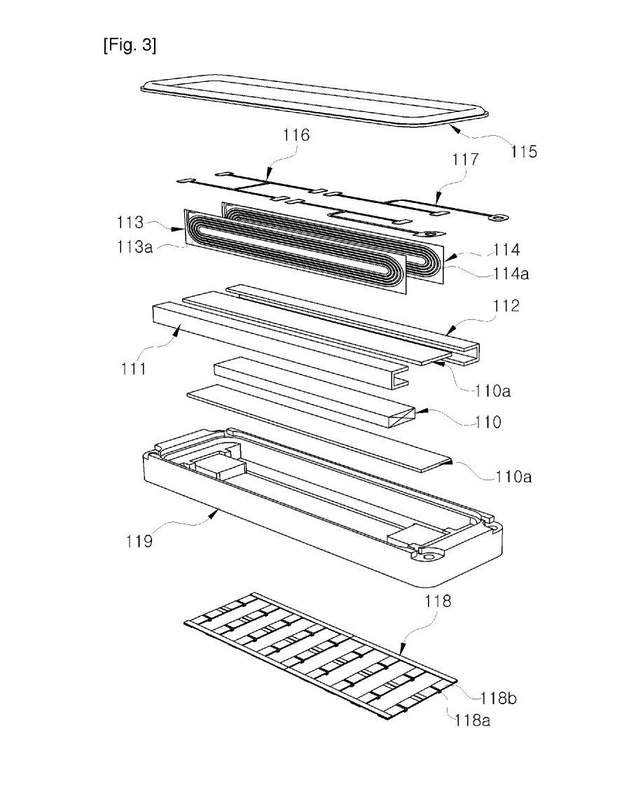

FIG. 1 is an assembly diagram of a flat-type speaker in which two voice coil plates are joined to one magnet according to a preferred embodiment of the present invention, FIG. 2 is a sectional view of the flat-type speaker in which the two voice coil plates are joined to one magnet according to the preferred embodiment of the present invention, and FIG. 3 is an exploded perspective view of the flat-type speaker in which the two voice coil plates are joined to one magnet according to the preferred embodiment of the present invention.

As shown in FIGS. 1 to 3, the flat-type speaker in which the two voice coil plates are joined to one magnet according to the preferred embodiment of the present invention includes: one magnet 110, first and second yoke plates 111 and 112, two voice coil plates 113 and 114, a diaphragm 115, first and second lead plates 116 and 117, a damper 118, and a base frame 119.

The one magnet 110 is arranged at the center of the flat-type speaker, and magnet plates 110a are respectively joined to upper and lower faces of the magnet 110. Differently from conventional speakers, the flat-type speaker according to the preferred embodiment of the present invention does not use a pair of magnets but use just one magnet.

The first and second yoke plates 111 and 112 are located at right and left sides of the magnet 110 and are made of a material which is capable of receiving a magnetic field of the magnet 110, preferably, is made of a virtual magnetic material with no magnetism.

Voice coils 113a and 114a are respectively coiled or pattern-printed on one side or both sides of the voice coil plates 113 and 114 into a track form, and in this instance, one 113 of the voice coil plates is inserted between the magnet 110 and the first yoke plate 111 and the other one 114 is inserted between the magnet 110 and the second yoke plate 112.

After that, when electricity flows to the voice coils 113a and 114a of the voice coil plates 113 and 114, an induced electromotive force is generated between the magnet 110 and the yoke plates 111 and 112 by the Fleming's left-hand rule and the Lorentz force law, such that the voice coil plates 113 and 114 move up and down by the induced electromotive force.

The diaphragm 115 serves to transfer vibration energy from the voice coil plates 113 and 114 as sounds.

The first and second lead plates 116 and 117 are interposed between the voice coil plates 113 and 114 and the diaphragm 115, and the first lead plate 116 assists the vertical movement of the voice coil plates 113 and 114 and realizes an electric connection through a face-to-face contact and soldering with the voice coils 113a and 114a, and the second lead plate 117 realizes a series connection of the two voice coils 113a and 114a.

The damper 118 is mounted at a lower end surface of the base frame 119, keeps the voice coil plates 113 and 114 at their home positions in order to prevent a biased vibration in a state where the two voice coil plates 113 and 114 are arranged parallel to each other, and serves to assist the vertical vibration of the voice coil plates 113 and 114.

The base frame 119 forms the outward appearance of the speaker and is a molded product made of a synthetic resin material to which various components are joined.

Referring to FIG. 2, the magnet 110 is arranged at the center of the flat-type speaker and the yoke plates 111 and 112 for receiving the magnetic field of the magnet 110 are mounted at both sides of the magnet 110 so as to induce circulation of the magnetic field.

In this instance, the yoke plates 111 and 112 are formed in a shape of ‘ [symbol] ’ in order to circulate the magnetic field smoothly or in a shape of ‘=’ in a state where upper and lower ends are separated from each other.

Because the voice coils 113a and 114a of the two voice coil plates 113 and 114 have different poles from each other, electricity flows in a predetermined direction through the series connection between the voice coils 113a and 114a, so that the two voice coil plates 113 and 114 have the same vibration.

The two voice coil plates 113 and 114 keep their home positions in a state where they are seated through seating portions 118a of the damper 118, and the damper 118 includes a damper bridge 118b which is vibrated in interlock with vibration of the voice coil plates 113 and 114.

The first and second lead plates 116 and 117 are respectively connected to upper portions of the two voice coil plates 113 and 114 and are electrically connected with the voice coils 113a and 114a so as to receive electricity.

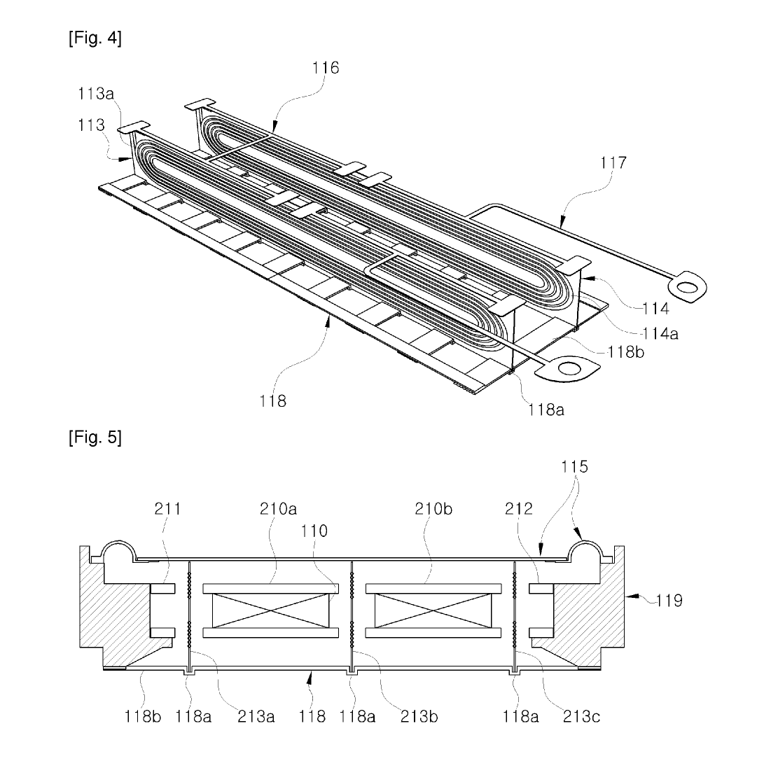

FIG. 4 is a perspective view showing structures and connection structures of the voice coil plates, lead plates and a damper of the flat-type speaker according to the present invention.

The first lead plate 116 is formed in a shape of alphabet letter “H”, and includes: a series connection spline 116a which is a central line for connecting the two voice coils 113a and 114a in series; base splines 116b elongated at both sides for a face-to-face contact with the diaphragm 115; and connection terminals 116c formed at front ends of the base splines 116b, the connection terminals 116c being soldered for the face-to-face contact with the voice coils 113a and 114a.

The second lead plates 117 includes: base splines 117a elongated at both sides; wing splines 117b respectively extended from the center of the base splines 117a in order to serve as a damper for transferring vibration to the diaphragm 115; connection terminals 117c respectively formed at front ends of the base splines 117a, the connection terminals 117c being soldered for the face-to-face contact with the voice coils 113a and 114a; and power supply terminals 117d respectively formed at front ends of the wing splines 117b in order to receive electricity from the outside and to apply electricity to the voice coil plates 113 and 114. Differently from the base splines 116b of the first lead plate 116, the base splines 117a of the second lead plate 117 are not connected with each other.

One of the base splines 116b and one of the base splines 117a are respectively in face-to-face contact with the upper end surface of one voice coil plate 113, and the other ones are respectively in face-to-face contact with the upper end surface of the other voice coil plate 114.

The connection terminals 116c and the power supply terminals 117d may be in the form of a copper sheet.

Therefore, the first lead plate 116 is attached to a lower portion of the diaphragm 115 and can control a flow direction of electricity according to the direction of the magnetic field through the series connection of the two voice coil plates 113 and 114, and the second lead plate 117 serves as a damper to transfer vibration of the voice coil plates 113 and 114 to the diaphragm 115 so as to transfer much more sound energies. The power supply terminals 117d of the second lead plate 117 respectively have positive and negative poles so as to serve as a lead wire which can apply electricity to the voice coils 113a and 114a. The first lead plate 116 serves as a lead wire for the series connection such that the two voice coil plates 113 and 114 can vibrate in the same direction on the same cycle without any biased vibration.

The damper 118 has rectangular frames, and includes: a plurality of damper bridges 118b for connecting the frames with each other; and seating portions 118a formed at central portions of the damper bridges 118b to which the voice coil plates 113 and 114 are inserted and seated.

Moreover, four sides of the damper 118 may be exactly located at a damper guide (not shown) formed at the outskirt of the lower end of the base frame 119.

According to the modification of the flat-type speaker described above, the flat-type speaker may be manufactured in such a manner that one voice coil plate is inserted between one magnet and one yoke plate. Alternatively, the flat-type speaker may be manufactured in such a manner that the voice coil plates are respectively inserted between one magnet and one of the yoke plate and between the magnet and the other one of the yoke plate and another magnet so as to form one set and at least one set is horizontally arranged or a plurality of the sets are horizontally arranged by adding another magnets to the voice coil plates.

FIG. 5 is a sectional view of a flat-type speaker in which n+1 voice coil plates are joined to n magnets according to another preferred embodiment of the present invention.

As shown in the drawing, the flat-type speaker according to the second preferred embodiment of the present invention includes two magnets 210a and 210b; yoke plates 211 and 212 respectively formed at both sides of the magnets 210a and 210b; and three voice coil plates 213a, 213b and 213c respectively inserted into spaces between the magnets and the yoke plates.

Likewise, in the case that three magnets are located, four voice coil plates are interposed between the magnets so as to realize a flat-type speaker requiring a large output.

That is, in the case that n (positive integer) magnets are arranged, in order to form a flat-type speaker, a pair of yoke plates are arranged at both sides of the magnets and n+1 voice coil plates are respectively inserted between the magnets.

The conventional flat-type speaker has a pair of magnets and one voice coil plate inserted between the magnet, namely, has 2m (positive integer) magnets and m voice coil plates inserted between the magnets, but differently from the conventional flat-type speaker, the flat-type speaker according to the preferred embodiment of the present invention can provide a large output in a small size by reducing the number of the magnets.

As described above, while the present invention has been particularly shown and described with reference to the example embodiments thereof, it will be understood by those of ordinary skill in the art that the present invention may be carried out in other forms without changing the essential characteristics and scope of the present invention. Therefore, it would be understood that the above embodiments of the present invention are all exemplified and the present invention is not limited to the above embodiments. Moreover, it will be understood that the scope of the present invention is defined by the following claims and various changes, modifications and equivalents derived from the meaning and the scope of the claims may belong to the scope of the present invention.

[Explanation of essential reference numerals in drawings]

| | |
|---|---|
| 110: magnet | 110a: magnet plate |
| 111, 112: yoke plate | 113, 114: voice coil plate |
| 113a, 114a: voice coil | 115: diaphragm |
| 116, 117: lead plate | 118: damper |
| 119: base frame | |

1. A flat-type speaker comprising:
n magnets and n+1 voice coil plates, the flat-type speaker the flat-type speaker including:
one magnet located at a central portion;
a pair of yoke plates spaced apart from the magnet at a predetermined interval in such a way that the magnet is interposed between the yoke plates;
two voice coil plates respectively having voice coils which are inserted between the magnet and one of the yoke plates and between the magnet and the other one of the yoke plates; and
a diaphragm vibrated by receiving vibration of the voice coil plates in a state where the diaphragm gets in contact with upper ends of the voice coil plates.

2. A flat-type speaker comprising:
n magnets and n+1 voice coil plates, the flat-type speaker the flat-type speaker including:
at least two magnets located at a central portion and spaced apart from each other at a predetermined interval;
a pair of yoke plates spaced apart from the magnets at a predetermined interval in such a way that the magnets are interposed between the yoke plates;
voice coil plates respectively having voice coils which are inserted between the magnets and one of the yoke plates and between the magnets and the other one of the yoke plates; and
a diaphragm vibrated by receiving vibration of the voice coil plates in a state where the diaphragm gets in contact with upper ends of the voice coil plates.

3. The flat-type speaker according to claim 1, wherein first and second lead plates respectively are in face-to-face contact between the voice coil plates and the diaphragm.

4. The flat-type speaker according to claim 3, wherein the first lead plate comprises: base splines getting in face-to-face contact with upper ends of the voice coil plates and getting in face-to-face contact with a lower surface of the diaphragm; a series connection spline for connecting central portions of the base splines; and connection terminals formed at front ends of the base splines so as to be electrically connected with the voice coils formed on the voice coil plates.

5. The flat-type speaker according to claim 2, wherein the second lead plate comprises: base splines getting in face-to-face contact with upper ends of the voice coil plates and getting in face-to-face contact with a lower surface of the diaphragm; wing splines outwardly formed from central portions of the base splines; and connection terminals formed at front ends of the wing splines for receiving electricity from the outside.

6. The flat-type speaker according to claim 1, wherein the yoke plates are formed in a shape of ‘ [symbol] ’ or in a shape of ‘=’ in section by being joined with each other integrally or separately.

7. The flat-type speaker according to claim 1, wherein a rectangular damper is joined to lower end portions of the two voice coil plates and comprises a plurality of damper bridges spaced apart from each other and disposed for connecting damper frames with each other, and
wherein lower end surfaces of the two voice coil plates are respectively seated on seating portions located at vertically central portions of the damper bridges.

8. The flat-type speaker according to claim 2, wherein first and second lead plates respectively are in face-to-face contact between the voice coil plates and the diaphragm.

9. The flat-type speaker according to claim 2, wherein the yoke plates are formed in a shape of ‘ [symbol] ’ or in a shape of ‘=’ in section by being joined with each other integrally or separately.

10. The flat-type speaker according to claim 2, wherein a rectangular damper is joined to lower end portions of the two voice coil plates and comprises a plurality of damper bridges spaced apart from each other and disposed for connecting damper frames with each other, and
wherein lower end surfaces of the two voice coil plates are respectively seated on seating portions located at vertically central portions of the damper bridges.
